(19) United States
(12) Patent Application Publication
(10) Pub. No.: US 2016/0189822 A1
(43) Pub. Date: Jun. 30, 2016

(54) Conductive Film and Method for Preparing the Same

(71) Applicant: National University of Kaohsiung, Kaohsiung City (TW)

(72) Inventors: Chien-Jung Huang, Kaohsiung City (TW); Ching-Nan Chen, Kaohsiung City (TW); Teen-Hang Meen, Kaohsiung City (TW); Yu-Hao Chen, Kaohsiung City (TW)

(21) Appl. No.: 14/817,453

(22) Filed: Aug. 4, 2015

(30) Foreign Application Priority Data
Dec. 27, 2014 (TW) 103145914

(51) Int. Cl. H01B 1/12; B05D 5/00

(52) U.S. Cl. CPC H01B 1/127; B05D 5/00

(57) ABSTRACT

A method for preparing a conductive film includes: (a) providing a mixture that includes a conductive material and a solvent, the conductive material including polyethylenedioxythiophene and polystyrene sulfonate; (b) filtering the mixture to obtain a filtrate; (c) heating and stirring the filtrate to form a film-forming solution; (d) coating the film-forming solution onto a substrate to form a crude film on the substrate; and (e) bringing the crude film into contact with methanesulfonic acid so as to form the conductive film on the substrate.

### CROSS-REFERENCE TO RELATED APPLICATION

This application claims priority of Taiwanese Application No. 103145914, filed on Dec. 27, 2014.

### FIELD

The disclosure relates to a method for preparing a conductive film.

### BACKGROUND

A conductive film of a photovoltaic element may be prepared from a conductive solution containing poly(3,4-ethylenedioxythiophene) (PEDOT) and polystyrene sulfonate (PSS), which may be referred to as PEDOT:PSS conductive solution. Through addition of PSS, solubility of PEDOT in water can be increased. The PEDOT:PSS conductive solution has been widely used in preparation of a conductive film on a substrate through spin coating.

The conductive film formed from PEDOT:PSS conductive solution may be used in preparation of a polymeric light emitting diode (PLED), an organic light emitting diode (OLED), an organic thin film solar cell (OPV) or an organic thin film transistor (OTFT), etc. The PEDOT:PSS conductive solution has excellent film-forming properties, stability and operability. The conductive film formed from the PEDOT:PSS conductive solution has good light transmittance, heat resistance and chemical stability, and may achieve better flatness on a substrate surface on which the conductive film is formed. However, the conductive film has poor conductivity (i.e., a high sheet resistance).

In order to overcome the aforementioned problem regarding poor conductivity, several studies [Synth. Met., vol. 126, p311-316 (2002); European Polymer Journal, vol. 45, p256-261 (2009); Synth. Met., vol. 164, p38-41(2013)] have proposed to add a solvent, such as glycerol, dimethylsulfoxide (DMSO), diethylene glycol or sorbitol, into the PEDOT:PSS conductive solution so as to enhance the conductivity (e.g., by reducing the sheet resistance) of the conductive film thus formed.

Addition of the solvent can introduce phase separation (i.e., PEDOT and PSS) after the PEDOT:PSS conductive solution is coated and dried on a substrate to form the conductive film. During film forming, PEDOT particles aggregate at an outer surface of the conductive film, while PSS particles migrate to and aggregate at an inner surface of the conductive film, which results in increased conductivity of the conductive film. However, the phase separation undesirably increases the surface roughness of the conductive film.

Therefore, there remains a need to improve the aforesaid method to obtain a PEDOT:PSS conductive film having greater conductivity and lower surface roughness.

### SUMMARY

Therefore, an object of the disclosure is to provide a method for preparing a conductive film that can alleviate at least one of the drawbacks of the prior arts.

According to one aspect of the disclosure, there is provided a method for preparing a conductive film. The method includes: (a) providing a mixture that includes a conductive material and a solvent, the conductive material including polyethylenedioxythiophene and polystyrene sulfonate; (b) filtering the mixture to obtain a filtrate; (c) heating and stirring the filtrate to form a film-forming solution; (d) coating the film-forming solution onto a substrate to form a crude film on the substrate; and (e) bringing the crude film into contact with methanesulfonic acid so as to form the conductive film on the substrate.

According to another aspect of the disclosure, there is provided a conductive film prepared by the aforementioned method. The conductive film includes a base layer of polystyrene sulfonate, a layer of polyethylenedioxythiophene particles disposed on the base layer, and methanesulfonic acid residual chemically bonded to the layer of polyethylenedioxythiophene particles.

According to yet another aspect of the disclosure, there is provided a conductive film comprising a base layer of polystyrene sulfonate, a layer of polyethylenedioxythiophene particles disposed on the base layer, and methanesulfonic acid residual chemically bonded to the layer of polyethylenedioxythiophene particles.

### BRIEF DESCRIPTION OF THE DRAWINGS

Other features and advantages of the disclosure will become apparent in the following detailed description of the embodiments with reference to the accompanying drawing, of which:

FIG. 1 is a schematic view illustrating the embodiment of a conductive film according to the disclosure.

### DETAILED DESCRIPTION

The embodiment of a method for preparing a conductive film according to the disclosure includes: (a) providing a mixture that includes a conductive material and a solvent, the conductive material including polyethylenedioxythiophene (PEDOT) and polystyrene sulfonate (PSS); (b) filtering the mixture to obtain a filtrate; (c) heating and stirring the filtrate to forma film-forming solution containing PEDOT particles and PSS particles; (d) coating the film-forming solution onto a substrate to form a crude film on the substrate; and (e) bringing the crude film into contact with methanesulfonic acid so as to form the conductive film on the substrate.

Since the film-forming solution is formed from the filtrate, a narrower particle size range of the PEDOT and PSS particles of the film-forming solution may be achieved, which renders the conductive film thus formed a lower surface roughness. Moreover, due to the heating and stirring in step (c), concentration of PEDOT in the film-forming solution is increased. In the crude film formed in step (d), the PEDOT particles are aggregated at an outer surface of the crude film. Contact of the crude film with methanesulfonic acid in step (e) enhances phase separation between PEDOT and PSS at the outer surface of the crude film, thereby increasing the conductivity of the conductive film thus obtained.

It should be understood that there is no particular limitation to the solvent as long as the solvent may be useful to enhance the conductivity of the mixture in step (a). The solvent may be an organic or inorganic solvent. Preferably, the solvent may be selected from the group consisting of dimethyl sulfoxide, ethylene glycol, glycerol, aqueous sulfuric acid, polyethylene glycol, sorbitol, xylitol, volemitol, and combinations thereof.

Preferably, in step (a), based on the total weight of the mixture, the solvent is in an amount ranging from 2 to 5 wt %. When the amount of the solvent is less than 2 wt %, the conductivity of the conductive film thus formed may not be satisfactory. In an embodiment of this disclosure, the solvent is in an amount of 4 wt % based on the total weight of the mixture.

Preferably, the polyethylenedioxythiophene particles may have a particle size less than 1.2μ m.

Preferably, in step (c), the heating temperature ranges from 70 to 90° C. In certain embodiments of this disclosure, the heating temperature ranges from 75 to 85° C.

Preferably, in step (c), the stirring rate ranges from 300 to 500 rpm.

Preferably, in step (c), the stirring time ranges from 3 to 10 minutes. When the stirring time is less than 3 minutes, the conductivity of the conductive film thus formed may not be satisfactory.

Preferably, the film-forming solution is spin coated onto the substrate to form the crude film.

In certain embodiments of this disclosure, in step (e), the crude film contacts with methanesulfonic acid at a temperature ranging from 15 to 35° C. In certain embodiments of this disclosure, the crude film contacts with methane sulfonic acid at a temperature ranging from 20 to 30° C.

In certain embodiments of this disclosure, in step (e), the crude film contacts with methanesulfonic acid at a temperature ranging from 140 to 160° C. In certain embodiments of this disclosure, the crude film contacts with methane sulfonic acid at a temperature ranging from 145 to 155° C.

In certain embodiments of this disclosure, step (e) is carried out twice, the first one being conducted at a temperature ranging from 15 to 35° C., the second one being conducted at a temperature ranging from 140 to 160° C.

Preferably, in step (e), the contact time of the crude film and methanesulfonic acid ranges from 4 to 6 minutes.

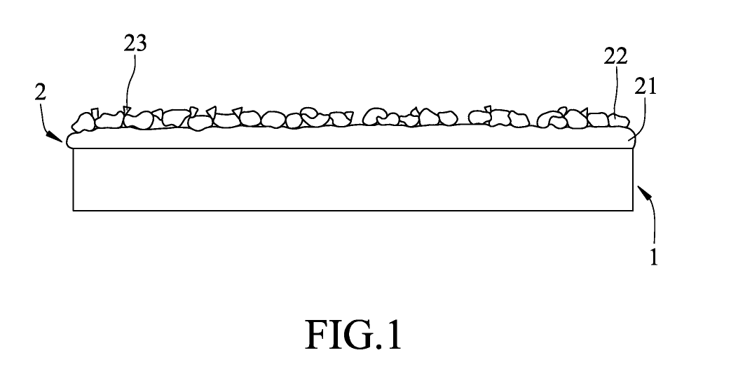

Referring to FIG. 1, the embodiment of the conductive film 2, which is prepared by the aforementioned method and which is formed on a substrate 1, includes a base layer 21 of polystyrene sulfonate, a layer of polyethylenedioxythiophene particle 22 disposed on the base layer 21, and methanesulfonic acid residuals 23. The methanesulfonic acid residuals 23 are chemically bonded to the layer of polyethylenedioxythiophene particles 22.

The following examples are provided to illustrate certain embodiments of the disclosure, and should not be construed as limiting the scope of the disclosure.

### EXAMPLES

### Example 1 (E1)

A conductive film of Example 1 was prepared through the following steps:

Step (1): 5 g of PEDOT:PSS conductive solution (purchased from Heraeus Co.) was placed into a glass beaker. 0.208 g of 3.99 wt % sorbitol (purchased from Sigma Aldrich) was added into the glass beaker and was stirred at 400 rpm for 30 minutes to obtain a mixture.

Step (2): 2 g of the mixture was filtrated through a syringe filter to obtain a filtrate. 1 g of the filtrate was placed into a second beaker. The pore size of the syringe filter for Example 1 is shown in Table 1.

Step (3): the filtrate in the second beaker was heated and stirred at 80° C. for 3 minutes to form a film-forming solution. The stirring rate was 400 rpm.

Step (4): 100 μL of the film-forming solution was coated onto a glass substrate using a spin coating machine. The glass substrate coated with the film-forming solution was baked at a temperature of 150° C. for 20 minutes to form a crude film of Example 1. It is noted that, the spin coating procedure was conducted in two stages, and that the stirring rate at the first stage was 1000 rpm and the stirring rate at the second stage was 3500 rpm.

Step (5): 100 μL of 98 wt % methanesulfonic acid was dropwisely applied to the crude film to allow methanesulfonic acid to contact the crude film under 25° C. for 5 minutes. The crude film was then rinsed with water for 10 seconds, and was subsequently dried in an oven at 150° C. for 10 minutes to obtain a conductive film of Example 1.

### Examples 2 to 4 (E2 to E4)

The procedures and conditions in preparing the conductive film of each of Examples 2 to 4 were similar to those of Example 1, except for the pore size of the syringe filter (see Table 1). In addition, there were other differences among Examples 2 to 4. In Example 2, step (5) was carried out twice. In Example 3, step (5) was carried out three times. In Example 4, immediately after methanesulfonic acid was dropwisely applied to the crude film in step (5), the crude film was heated to 150° C. in an oven to allow methanesulfonic acid to contact the crude film under 150° C. for 5 minutes, was then rinsed with water for 10 seconds and was subsequently dried in the oven at 150° C. for 10 minutes to obtain the conductive film of Example 4.

### Examples 5 to 6 (E5 to E6)

The procedures and conditions in preparing the conductive film of Example 5 were similar to those of Example 4 except that the pore size of the syringe filter was 0.2 μm, that step (5) was carried out twice and that the stirring time in step (3) was 10 minutes.

The procedures and conditions in preparing the conductive film of Example 6 were similar to those of Example 4, except that the pore size of the syringe filter was 0.45 μm, that step (5) was carried out three times and that the stirring time in step (3) was 10 minutes.

### Examples 7 to 9 (E7 to E9)

The procedures and conditions in preparing the conductive film of Example 7 were similar to those of Example 2, except that step (5) was carried out three times and that methanesulfonic acid was allowed to contact the crude film under 25° C. for 5 minutes at the firstly conducted step (5) and under 150° C. for 5 minutes at the secondly and thirdly conducted steps (5).

The procedures and conditions in preparing the conductive film of Example 8 were similar to those of Example 7, except that the stirring time in step (3) was 5 minutes.

The procedures and conditions in preparing the conductive film of Example 9 were similar to those of Example 2, except that the stirring time in step (3) was 7 minutes.

TABLE 1

| | Pore size of the | Stirring time |
|---|---|---|
| | syringe filter | in step (3) |
| Example | (μm) | (min) |
| E1 | 0.2 | 9 |
| E2 | 0.45 | |
| E3 | 0.8 | |
| E4 | 1.2 | |
| E5 | 0.2 | 10 |
| E6 | 0.45 | |
| E7 | 0.45 | 3 |
| E8 | 0.45 | 5 |
| E9 | 0.45 | 7 |

### Comparative Example 1 (CE1)

The procedures and conditions in preparing the conductive film of Comparative Example 1 were similar to those of Example 1, except that the mixture did not undergo filtration.

### Comparative Example 2 (CE2)

The procedures and conditions in preparing the conductive film of Comparative Example 2 were similar to those of Example 5, except that the mixture did not undergo filtration.

### Comparative Example 3 (CE3)

The procedures and conditions in preparing the conductive film of Comparative Example 3 were similar to those of Example 7, except that the mixture was free of the sorbitol solution, and the filtrate did not undergo heating and stirring in step (3) and was directly applied to the glass substrate.

### Comparative Example 4 (CE4)

The procedures and conditions in preparing the conductive film of Comparative Example 4 were similar to those of Example 7, except that the filtrate did not undergo heating and stirring in step (3) and was directly applied to the glass substrate.

### <Performance Test for the Crude Film>

### Sheet Resistance Test:

The sheet resistance of the crude film obtained in step (4) of each of Examples 1 to 9 and Comparative Examples 1 to 4 was measured using a four point sheet resistivity meter (Model No. SRM103, manufactured by Solar Energy Technology, Taiwan).

### Transmittance Test:

The transmittance of the crude film of each Examples 1 to 9 and Comparative Examples 1 to 4 was measured using an UV/visible spectrometer (Model No. U-3900, manufactured by HITACHI Company).

### Roughness Test:

The roughness of the crude film of each of Examples 1 to 9 and Comparative Examples 1 to 4 was measured using an atomic force microscope (AFM, Model No. XE-70, manufactured by Park Systems Company).

The test results are shown in Tables 2, 3 and 4.

TABLE 2

| | Pore size of the | Sheet | | |
|---|---|---|---|---|
| | syringe filter | resistance | Transmittance | Roughness* |
| | (μm) | (Ω/sq) | (%) | (nm) |
| E1 | 0.2 | 107 | 86.6 | 5.3 |
| E2 | 0.45 | 106 | 85.3 | 6 |
| E3 | 0.8 | 110 | 87.7 | 6.8 |
| E4 | 1.2 | 94 | 85.3 | 7.1 |
| CE1 | unfiltered | 95 | 86.6 | 11.5 |

*Measurement area: 10 μm × 10 μm

As shown in Table 2, the roughness of the crude film of each of Examples 1 to 7 is much smaller than that of Comparative Example 1. The smaller the pore size of the syringe filter, the smaller the particle size of the PEDOT particles and the smaller the roughness of the crude film will be.

TABLE 3

| | Pore size of the | Sheet | | |
|---|---|---|---|---|
| | syringe filter | resistance | Transmittance | Roughness* |
| | (μm) | (Ω/sq) | (%) | (nm) |
| E5 | 0.2 | 95 | 87.1 | 1.89 |
| E6 | 0.45 | 85 | 86.7 | 1.91 |
| CE2 | unfiltered | 80 | 83.4 | 2.91 |

*Measurement area: 5 μm × 5 μm

As shown in Table 3, the roughness of the crude films of each of Examples 5 and 6 is much smaller than that of Comparative Example 2.

TABLE 4

| | Stirring time | Sheet |
|---|---|---|
| | in step (3) | resistance |
| | (min) | (Ω/sq) |
| E7 | 3 | 100.3 |
| E8 | 5 | 81.3 |
| E9 | 7 | 71 |
| E2 | 9 | 58.7 |
| CE3 | Step (3) was skipped | ~55000 |
| CE4 | Step (3) was skipped | 225 |

As shown in Table 4, the sheet resistance of Comparative Example 3 is much higher than those of Examples 2 and 7 to 9. The sheet resistance of Comparative Example 4 is higher than those of Examples 2 and 7 to 9. By heating and stirring the filtrate according to the method of this disclosure, the PEDOT:PSS crude film having a low sheet resistance can be easily achieved, which, in turn, increases the conductivity of the conductive film.

### <Performance Test for the Conductive Film>

The sheet resistance, transmittance and roughness of the conductive film of each of Examples 1 to 7 were measured using the aforementioned methods. The test results are shown in Tables 5, 6 and 7.

TABLE 5

| | Sheet | |
|---|---|---|
| | resistance | Transmittance |
| | (Ω/sq) | (%) |
| E1 | 84 | 86.0 |
| | (conductive film) | |
| E2 | 82 | 86.2 |
| | (conductive film) | |
| E3 | 79 | 86.3 |
| | (conductive film) | |
| E7 | 90 | 84.2 |
| | (crude film) | |

As shown in Table 5, the sheet resistances of the conductive films of Examples 1, 2 and 3 are lower than that of the crude film of Example 7.

TABLE 6

| | Sheet | |
|---|---|---|
| | resistance | Transmittance |
| | (Ω/sq) | (%) |
| E4 | 52 | 82.0 |
| | (conductive film) | |
| E5 | 48 | 79.3 |
| | (conductive film) | |
| E6 | 46 | 78.9 |
| | (conductive film) | |
| E2 | 65 | 81.4 |
| | (crude film) | |

As shown in Table 6, the sheet resistances of the conductive films of Examples 4 to 6 are lower than that of the crude film of Example 2.

The test results show that contacting the crude film with methanesulfonic acid may significantly lower the sheet resistance of the film, and that the higher the number of times of contacting the crude film with methanesulfonic acid, the lower the sheet resistance of the conductive film and the higher the conductivity of the conductive film will be.

TABLE 7

| | Sheet | |
|---|---|---|
| | resistance | Transmittance |
| | (Ω/sq) | (%) |
| E7 | 43 | 82.6 |
| | (conductive film) | |
| E2 | 58 | 77.3 |
| | (crude film) | |

As shown in Table 7, the conductive film of Example 7 has a higher transmittance and a lower sheet resistance than those of the crude film of Example 2.

In conclusion, by filtering the mixture, heating and stirring the filtrate, and bringing the crude film into contact with methanesulfonic acid according to the method of the disclosure, the drawbacks associated with the prior art may be alleviated.

While the present disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method for preparing a conductive film, comprising:
(a) providing a mixture that includes a conductive material and a solvent, the conductive material including polyethylenedioxythiophene and polystyrene sulfonate;
(b) filtering the mixture to obtain a filtrate;
(c) heating and stirring the filtrate to form a film-forming solution;
(d) coating the film-forming solution onto a substrate to form a crude film on the substrate; and
(e) bringing the crude film into contact with methanesulfonic acid so as to form the conductive film on the substrate.

2. The method of claim 1, wherein, in step (a), the solvent is selected from the group consisting of dimethyl sulfoxide, ethylene glycol, glycerol, aqueous sulfuric acid, polyethylene glycol, sorbitol, xylitol, volemitol, and combinations thereof.

3. The method of claim 1, wherein, in step (a), based on the total weight of the mixture, the solvent is in an amount ranging from 2 to 5 wt %.

4. The method of claim 1, wherein, the filtrate contains polyethylenedioxythiophene particles that have a particle size less than 1.2 μm.

5. The method of claim 1, wherein, in step (c), the heating temperature ranges from 70 to 90° C.

6. The method of claim 1, wherein, in step (e), the crude film contacts with methanesulfonic acid at a temperature ranging from 15 to 35° C.

7. The method of claim 1, wherein, in step (e), the crude film contacts with methanesulfonic acid at a temperature ranging from 140 to 160° C.

8. The method of claim 1, wherein step (e) is carried out twice, the first one being conducted at a temperature ranging from 15 to 35° C., the second one being conducted at a temperature ranging from 140 to 160° C.

9. A conductive film prepared by the method as claimed in claim 1, the conductive film including abase layer of polystyrene sulfonate, a layer of polyethylenedioxythiophene particles disposed on the base layer, and methanesulfonic acid residual chemically bonded to the layer of polyethylenedioxythiophene particles.

10. A conductive film comprising: a base layer of polystyrene sulfonate; a layer of polyethylenedioxythiophene particles disposed on the base layer; and methanesulfonic acid residual chemically bonded to the layer of polyethylenedioxythiophene particles.
